(19) United States
(12) Patent Application Publication
(10) Pub. No.: US 2011/0310432 A1
(43) Pub. Date: Dec. 22, 2011

(54) COMPUTER READABLE RECORDING MEDIUM STORING PRINT SETTING PROGRAM, PRINT SETTING APPARATUS, COMPUTER READABLE RECORDING MEDIUM STORING CONTROL PROGRAM OF PRINTING APPARATUS, AND PRINTING APPARATUS

(75) Inventor: Shogo WAKI, Kawasaki-shi (JP)

(73) Assignee: Konica Minolta Business Technologies, Inc., Chiyoda-ku (JP)

(21) Appl. No.: 13/160,223

(22) Filed: Jun. 14, 2011

(30) Foreign Application Priority Data
Jun. 18, 2010 (JP) 2010-139808

(51) Int. Cl. G06K 15/00

(52) U.S. Cl. 358/1.15

(57) ABSTRACT

The printer driver according to the present invention causes the PC to execute steps of: determining whether or not the printer for executing print data is equipped with a Japanese device font based on information acquired from the printer (S103); and changing default values of the print settings for the print data so that font data for executing the print data will be downloaded to the printer if the step S103 determines that the printer is not equipped with a Japanese device font.

### CROSS-REFERENCE TO RELATED APPLICATION

This application is based on Japanese Patent Application No. 2010-139808 filed on Jun. 18, 2010, the contents of which are incorporated herein by reference.

### BACKGROUND

1. Technical Field

The present invention relates to a computer readable recording medium storing a print setting program and a print setting apparatus for configuring various print settings including font settings for print data, a computer readable recording medium storing a control program of a printing apparatus, and a printing apparatus.

2. Description of Related Arts

Generally, types of device fonts of pre-installed on a printer differ according to the countries or regions where the printer is intended to be used. For example, Japanese device fonts are often installed on printers for the Japanese market, but not on printers for the U.S. and European markets. This is not only due to costly royalty payment associated with use of any device font including a Japanese device font, but also due to larger computer resources consumed in use of a Japanese device font than those consumed in use of an European device font.

Similarly, printer drivers are equipped with localized UI screens written in their local languages, and a Japanese font can only be handled by a printer driver equipped with a Japanese UI screen—that is to say, a Japanese font cannot be handled by a printer driver equipped with a non-Japanese UI screen.

This means that print processing using a Japanese device font requires both a printer and a printer driver to support the Japanese device font, and even an print instruction from a printer driver supporting a Japanese device font will end up in troubles like garbled Japanese texts or an abnormal job termination if the printer does not support a Japanese device font.

For example, an employee working for a Japanese branch of a multinational company may be involved in the aforementioned troubles when he/she visits the U.S. head office and tries to print out a Japanese document from his/her mobile PC brought from Japan. In this example, the printer driver operating on the mobile PC obviously applies a Japanese device font, and therefore it generates print data (PDL data) which involves font substitution between system fonts and Japanese device fonts according to its default settings. However, the printer in the U.S. office is not equipped with a Japanese device font as it is obviously designed for the U.S. market. Therefore, the printer in the U.S. office will inevitably cause the troubles mentioned above when it receives the print data from the Japanese printer driver.

Under the circumstances, a user can possibly cancel the font substitution by manually changing print settings so that the printer will download font data for executing the print data. However, the user can hardly think of this scheme unless he/she is familiar with printer operations, and therefore the aforementioned troubles will substantially hamper user-friendliness of the printer.

In this respect Japanese Unexamined Publication No. 2004-192322 discloses a printing system comprised of: a print server for identifying device fonts which are not installed on a printing device out of those specified in PDL data received from a printer driver; and a data server (i.e. a font resource server) for distributing the identified device fonts by the printer server to the printing device. Theoretically, this system makes it possible to use device fonts for printing document data in any language including Japanese. However, the system necessitates a dedicated data server for storing an enormous amount of device fonts, and therefore it is far from providing a practical solution to the aforementioned troubles in printing documents.

The present invention is intended to solve the problems associated with prior art, and intends to provide a computer readable recording medium storing a print setting program, a print setting apparatus, a computer readable recording medium storing a control program of a printing apparatus, and a printing apparatus capable of prohibiting print settings which involve use of a device font in a particular language if the printing apparatus is not equipped with a device font in the particular language.

### SUMMARY

In order to achieve at least one of the aforementioned objectives, a computer readable recording medium, reflecting one aspect of the present invention, stores a print setting program for configuring print settings for print data, and the print setting program causes a computer to execute steps of: (A) determining whether or not a printing apparatus for executing said print data is equipped with a device font in a particular language, based on information acquired from said printing apparatus; and (B) changing default values of said print settings so that font data for executing said print data will be downloaded to said printing apparatus if said step (A) determines that said printing apparatus is not equipped with a device font in said particular language.

Preferably, said print setting program further causes said computer to execute a step of (a) determining whether or not default values of font substitution settings regarding substitution of device fonts for system fonts used for generating said print data have been changed by user, prior to said step (B); and said step (B) changes default values of said print settings only when said step (a) determines that default values of said font substitution settings have not been changed by user.

Preferably, said particular language is a language using multi-byte characters.

Preferably, said particular language is Japanese.

Preferably, said step (A) acquires said information in accordance with SNMP (Simple Network Management Protocol).

Preferably, said step (A) acquires said information using PJL (Printer Job Language) commands.

The objectives, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the structure of a printing system according to an embodiment of the present invention.

FIG. 2 isablock diagram showing the structure of the PC according to an embodiment of the present invention.

FIG. 3 is a block diagram showing the structure of a printer according to an embodiment of the present invention.

FIG. 4 is a functional block diagram of a printer driver according to an embodiment of the present invention.

FIG. 5 is a functional block diagram of a controller firmware according to an embodiment of the present invention.

FIG. 6 is a flowchart showing the steps of the processing by a printer driver according to an embodiment of the present invention.

FIG. 7 is a flowchart showing the steps of the Japanese device font installation determination by a printer driver according to an embodiment of the present invention.

FIG. 8 is a flowchart showing the steps of the default value setting by a printer driver according to an embodiment of the present invention.

FIG. 9 is a schematic diagram illustrating a font setting UI screen of a printer driver according to an embodiment of the present invention.

FIG. 10 is a schematic diagram illustrating a font setting UI screen of a printer driver according to an embodiment of the present invention.

FIG. 11 is a flowchart showing the steps of the processing by a controller firmware according to an embodiment of the present invention.

### DETAILED DESCRIPTION

The embodiments of this invention will be described below with reference to the accompanying drawings.

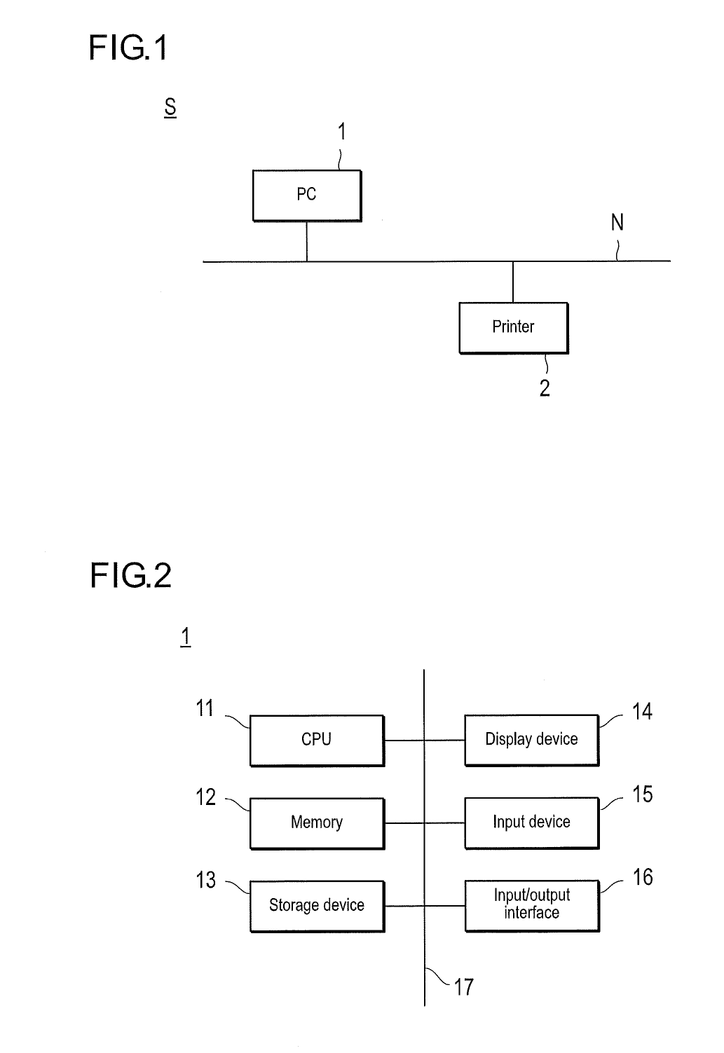

FIG. 1 is a block diagram showing the overall structure of a printing system S according to an embodiment of the present invention. As shown in FIG. 1, a printing system S includes a PC 1 which serves as a client, and a printer 2 which serves as a printing apparatus to execute print processing based on print data received from the PC 1, and these apparatuses are connected with each other via a network N. The network N is a LAN complying with a standard such as Ethernet®, Token Ring, FDDI, etc., or a WAN consisting of a plurality of LANs connected one another by a dedicated line. The PC 1 and the printer 2 can also be locally connected with each other.

The structures of the aforementioned apparatuses will be explained in detail below. FIG. 2 is a block diagram showing the structure of the PC 1 according to the present embodiment. As shown in FIG. 2, the PC 1 includes a CPU 11, a memory 12, a storage device 13, a display device 14, an input device 15, and an input/output interface 16, and these units are connected one another via a bus 17 for exchanging signals. Details of these units will be described below.

The CPU 11 is a control circuit consisting of a microprocessor for controlling each unit and performing various calculations in accordance with control programs, and each function of the PC 1 will be achieved when the CPU 11 executes a relevant program. The memory 12 is a main memory region including a RAM which functions as a working area for temporarily storing programs and data files, and a ROM for storing programs.

The storage device 13 is an auxiliary memory region such as a HDD for storing various programs including an operating system (OS). The storage device 13 particularly stores various application software programs for generating and editing document data for printing as well as a printer driver for configuring print settings for executing document files.

The display device 14 is a device for displaying various information to user, such as a liquid crystal display device. The display device 14 particularly displays an UI screen for print settings which is supplied by the printer driver. The UI screen for print settings can switch to detailed setting screens for various setting items like “Paper”, “Binding”, “Image quality”, and “Font” when user operates its tabs, buttons, etc. The following is an explanation of the “Font Setting” UI screen for detailed settings regarding device fonts used for the print processing.

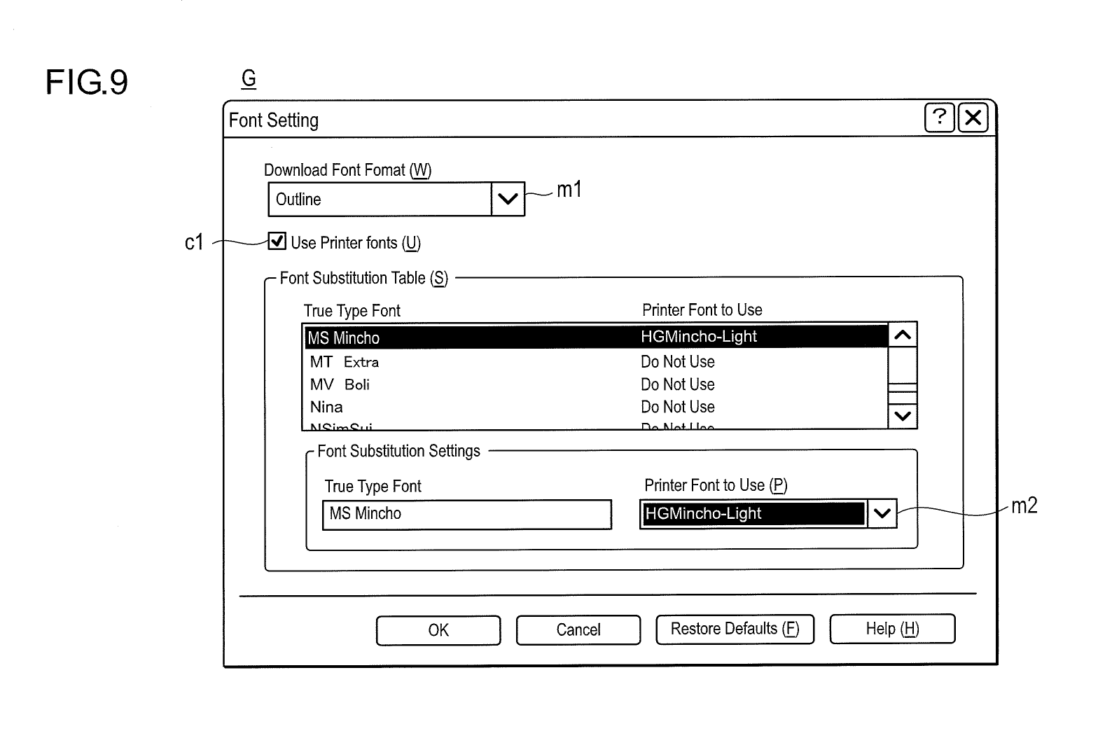

FIG. 9 is a schematic diagram illustrating the Font Setting UI screen G according to an embodiment of the present invention. As shown in FIG. 9, the Font Setting UI screen G has a pull-down menu m1 of “Download Font Format”, a check box c1 of “Use Printer Fonts”, “Font Substitution Table” showing substitution between “True Type Font” and “Printer Font to Use”, and a pull-down menu m2 of “Printer Font to Use”, etc. These widgets will be described below in detail.

The pull-down menu m1 of “Download Font Format” is used for specifying in which form font data will be downloaded to be used for print processing, and is composed of “Bitmap” and “Outline”.

The check box c1 of “Use Printer Fonts” is used to specify whether the printer will execute print processing involving use of pre-installed device fonts on the printer (hereinafter called “printer font”), or that involving use of downloaded font data. More specifically, the former is selected when the check box c1 is checked, and the latter is selected when the check box c1 is not checked.

“Font Substitution Table” indicates the current status of font substitution settings regarding substitution between system fonts (i.e. True Type fonts) and device fonts to be applied when the print processing involving use of printer fonts is selected. The pull-down menu m2 of “Printer Font to Use” is used to change the current status of the font substitution settings set forth in “Font Substitution Table”. Details of “Font Substitution Table” will be described later.

With reference to FIG. 2, the input device 15 includes a keyboard, a mouse, etc. for receiving operational instructions from user. The input/output interface 16 is an interface for connecting the PC 1 to the network N and for communicating with other devices including the printer 2 on the network N.

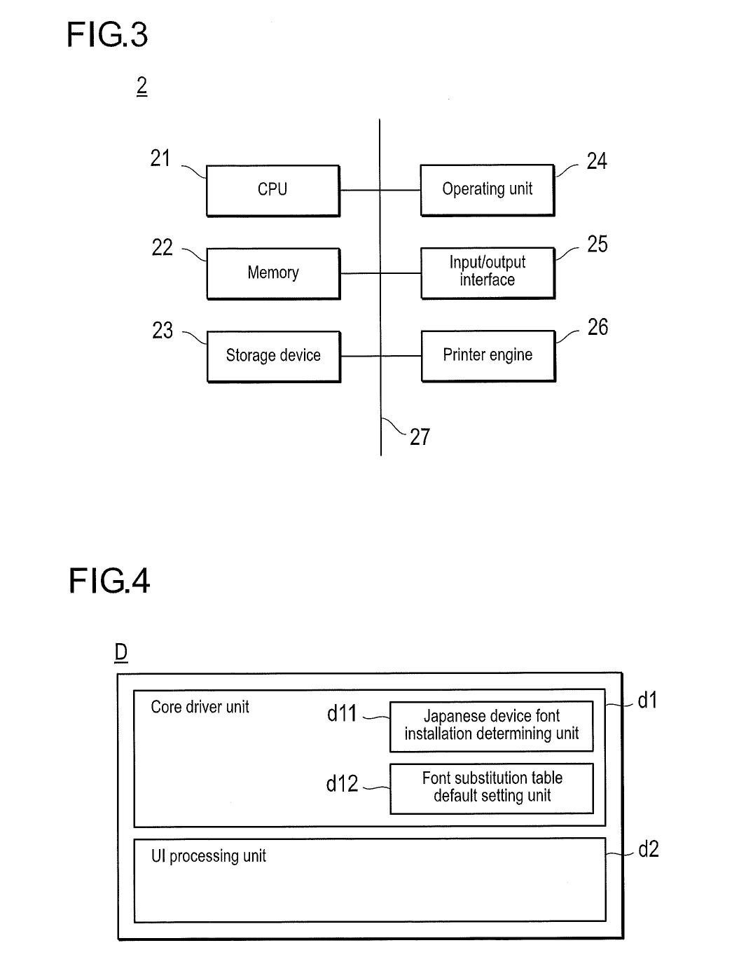

FIG. 3 is a block diagram showing the structure of the printer 2 according to an embodiment of the present invention. As shown in FIG. 3, the printer 2 includes a CPU 21, a memory 22, a storage device 23, an operating unit 24, an input/output interface 25, and a printer engine 26, and these units are connected via a bus 27 for exchanging signals. Each of these units will be described in detail below.

The CPU 21 is a control circuit consisting of a microprocessor for controlling each unit and performing various calculations, and each function of the printer 2 is achieved when the CPU 21 executes a relevant program. The memory 22 is the main memory region consisting of a RAM for temporarily storing programs and data files to serve as a working area, a ROM for storing various programs, etc.

The storage device 23 is a secondary storage device composed of a combination of a read-only storage device, a large-capacity random access storage device and so forth. The storage device 23 particularly stores a controller firmware F, details of which will be described later. The storage device 23 stores one or more Japanese device fonts, and these device fonts will be used when the check box c1 of “Use Printer Font” is checked on the Font Setting UI screen G illustrated in FIG. 9.

The operating unit 24 is an operation panel for user provided with a function to display various information on the printer 2 including its status information and setting information as well as a function to acquire various operational instructions from user. The input/output interface 25 is an interface for connecting the printer 2 to the network N and communicating with other devices on the network N including the PC 1.

The printer engine 26 is a printing device for printing image data generated by the language unit f2 of a controller firmware F, details of which will be described later. More specifically, the printer engine 26 prints the image data on recording paper using the electro-photographic printing method including a charging step for charging a photoconductive drum, an exposing step for forming an latent image on the photoconductive drum by laser beam, a developing step for forming a toner image by attaching toner to the latent image on the photoconductive drum, a transferring step for transferring the toner image on the photoconductive drum to the recording paper by a transferring belt, and a fusing step for heating and fusing the toner image transferred to the recording paper by a fuser roller. The printer engine can also adopt a different printing method such as the impact method, the thermal transfer method, and the ink-jet method instead of the electro-photographic method as described above.

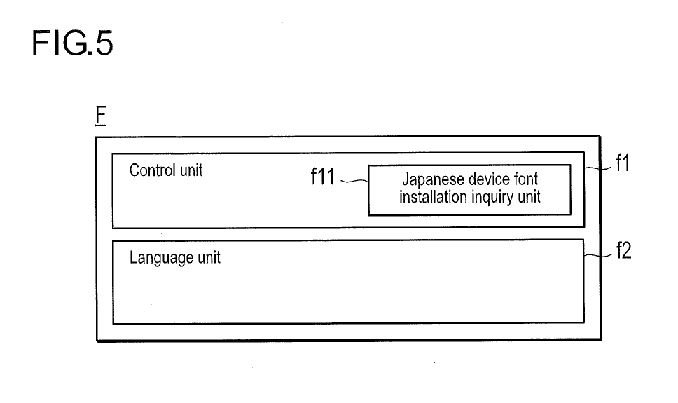

FIG. 4 is a functional block diagram of the printer driver D stored in the storage device 13 of the PC 1. As shown in FIG. 4, the printer driver D includes a core driver unit d1 for generating print data, and a UI processing unit d2 for controlling various UI screens. The core driver unit d1 further includes a Japanese device font installation determining unit d11, and a font substitution table default setting unit d12.

The Japanese device font installation determining unit d11 has a function to determine whether or not the printer 2 is equipped with Japanese device fonts based on information acquired from the printer 2. The font substitution table default setting unit d12 has a function to adjust default values of the font substitution table (See FIG. 9) based on the determination result by the Japanese device font installation determining unit d11. The functions of these units will be described more in detail later.

FIG. 5 is a function block diagram of the controller firmware F stored in the storage device 23 of the printer 2. As shown in FIG. 5, the control firmware F includes a control unit f1 for controlling the entire printer 2, and a language unit f2 for generating image data for print processing by the printer engine 26 based on print data received from the PC 1. The control unit f1 further includes a Japanese device font installation inquiry unit f11. The Japanese device font installation inquiry unit f11 has a function to sending information concerning the device fonts stored in the storage device 23, in response to an inquiry from the printer driver D. Details of this function will be described later.

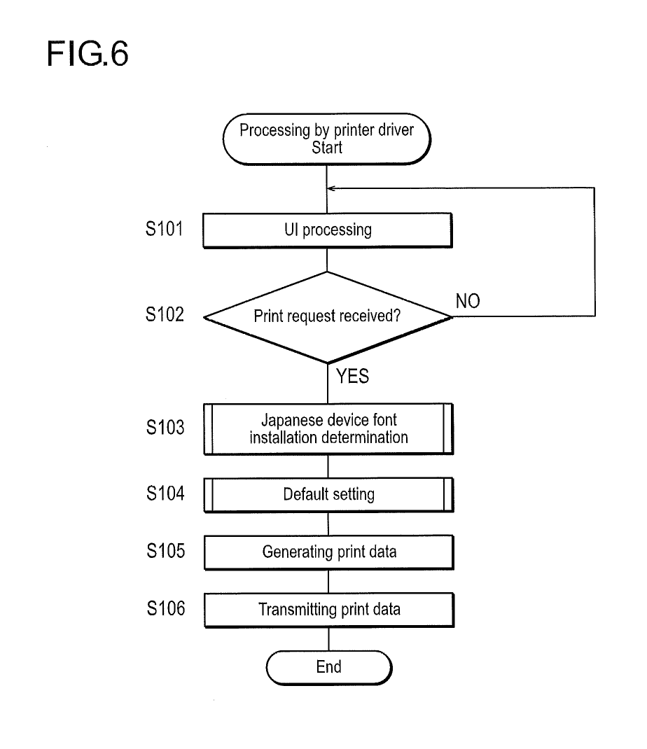

The following is the outline of the operations of the printing system S according to the present embodiment. FIG. 6 is a flowchart showing the steps of the processing by the printer driver D according to an embodiment of the present invention. The algorithm shown in the flowchart of FIG. 6 is stored as a control program in the storage device 13 of the PC 1, and is read into the memory 12 to be executed when the processing starts.

Firstly, the printer driver D executes UI processing by the UI processing unit d2 (S101). The UI processing herein includes both UI processing designed to start when an user opens a print setting screen (not shown) of the printer driver D in an attempt to print a document from an application software, and UI processing designed to start when an user opens the print setting screen (not shown) irrespective of the printing operations.

The printer driver D then determines whether or not it has received a print request from an application (S102). If the printer driver D has received a print request (S102: Yes), the Japanese device font installation determining unit d11 then executes Japanese device font determination (S103) in order to determine whether or not the printer 2 is equipped with a Japanese device font. On the other hand, if the printer driver D has not received a print request (S102: No), the program returns to the UI processing (S101).

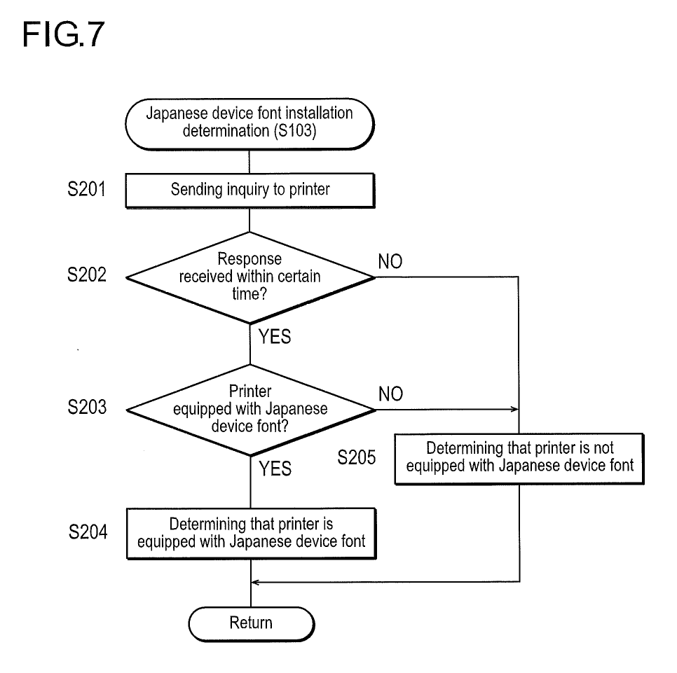

FIG. 7 is a flowchart showing the steps of the Japanese device font installation determination. (S103) executed by the Japanese device font determining unit d11. Firstly, the printer driver D establishes a communication with the printer 2, and inquires for information concerning the device fonts installed on the printer 2 (S201). More specifically, the printer driver D sends an inquiry to the printer 2 via the network N in accordance with a communication protocol such as SNMP (Simple Network Management Protocol), or using commands such as PJL (Printer Job Language) commands.

The printer driver D then determines whether or not the printer 2 is equipped with a Japanese device font, based on a response from the printer 2 (S203) if the printer driver D receive it within a certain period of time (S202: Yes). In this example, the response received by the printer driver D is either “Yes” or “No”, and the printer driver D determines that the printer 2 is equipped with a Japanese device font if it receives “Yes” (S204) while determining that the printer 2 is not equipped with a Japanese device font if it receives “No” (S205).

Meanwhile, the printer driver D determines that the printer 2 is not equipped with a Japanese device font (S205) if it receives no response from the printer 2 (S202: No). The printer driver D then returns to the flowchart in FIG. 6 (Return).

Referring to FIG. 6, the printer driver D executes default setting for adjusting default values of the font settings by the default setting unit d12 (S104).

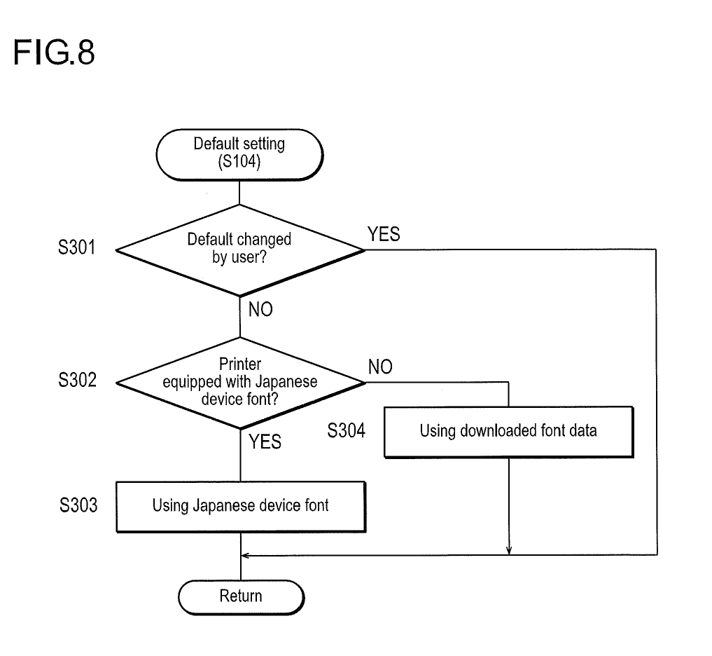

FIG. 8 shows a flowchart of the steps of the default setting (S104). Firstly, the printer driver D determines whether or not the Font Substitution Settings have already been changed by user on the Font Setting UI screen G in FIG. 9 (S301). The program returns to the flowchart in FIG. 6 without changing default values of the font settings if the Font Substitution Settings have been changed by user yet (S301: Yes). This is for the purpose of prioritizing the user-specified values of the Font Substitution Settings.

On the other hand, the printer driver D changes default values of the font settings (S303/S304) in accordance with the determination result (S302) of the Japanese device font installation determination (S103) if the Font Substitution Settings have not been changed by user (S301: No). More specifically, the printer driver D changes default values of the Font Substitution Settings so that a Japanese device font will be substituted for each Japanese system font for the purpose of reducing size of print data and speeding up image data generation (S303) if the printer 2 is equipped with a Japanese device font (S302: Yes).

FIG. 9 shows the Font Setting UI screen G reflecting the changed default values in S303. As shown in FIG. 9, the current status of the Font Substitution Table has been changed in a way that the Japanese device font “HGMincho-Light” compatible with the Japanese system font “MS Mincho” will be substituted for “MS Mincho”, accordingly. The printer driver D will eventually generate print data composed of font names and character codes alone.

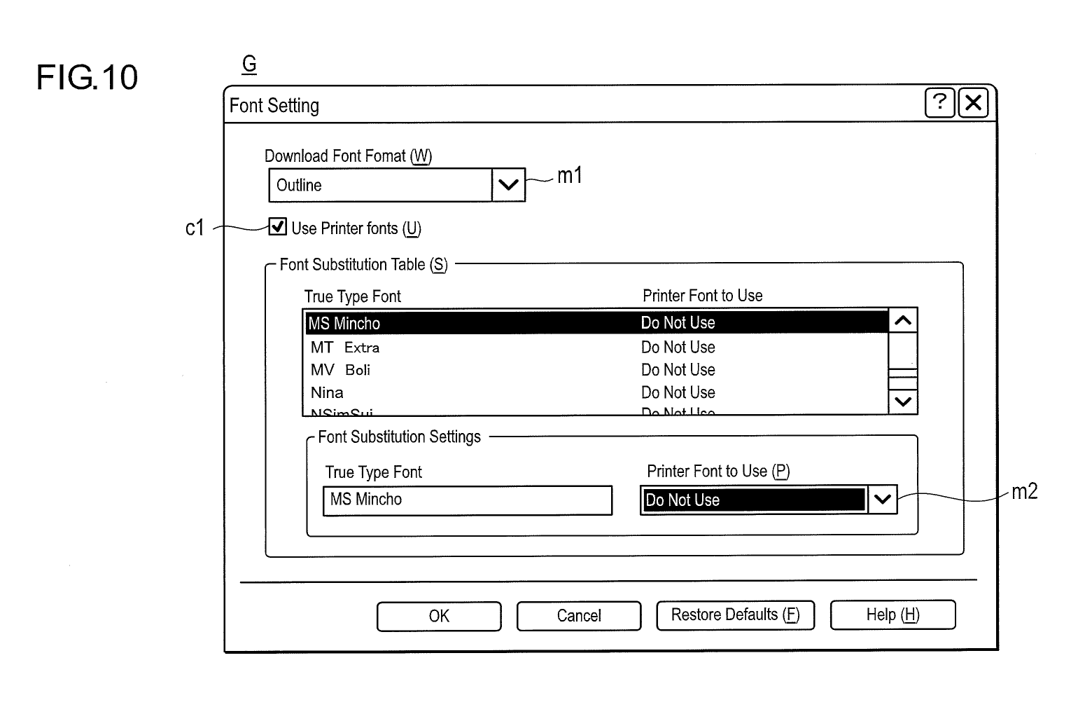

On the other hand, the printer driver D changes default values of the font substitution settings so that the print processing will be executed using downloaded font data (S304) if the printer 2 is equipped with no Japanese device font (S302: No). FIG. 10 shows the Font Setting UI screen G reflecting the changed default values in S304. As shown in FIG. 10, the current status of the Font Substitution Table has been changed so that no Japanese device font will be substituted for each Japanese system font. More specifically, the defaults values of “Printer Font to Use” for all the Japanese system fonts have been changed to “Do Not Use”. Consequently, the printer driver D can avoid abnormal completion of the print processing due to absence of a Japanese device font in the printer 2 because it transmits font data in outline or bitmap format to the printer 2.

With reference to FIG. 6, the printer driver D generates print data (S105) in accordance with the font settings reflecting the changed default values in S104, and terminates the series of steps (End) after transmitting the print data to the printer 2 via the network N (S106).

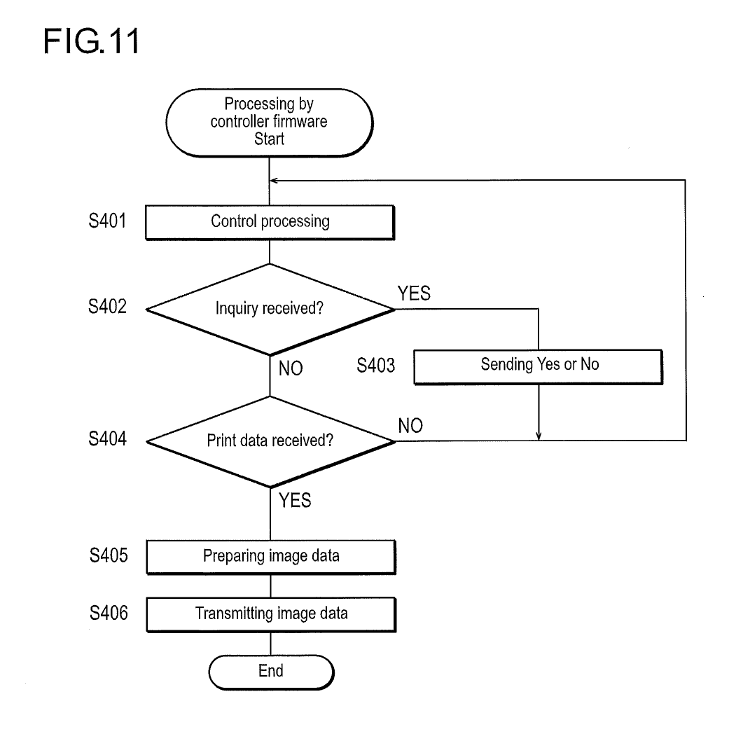

FIG. 11 is a flowchart showing the steps of the processing by the controller firmware F according to an embodiment of the present invention. The algorithm shown in the flowchart of FIG. 11 is stored as a control program in the storage device 23 of the printer 2, and is read into the memory 22 of the printer 2 when the processing starts.

Firstly, the controller firmware F executes control processing of the entire printer 2 by means of the control unit f1 (S401). The controller firmware F then determines whether or not it has received an inquiry from the printer driver D about installation of a Japanese device font (S402). The Japanese device font installation inquiry unit f11 sends an answer regarding the installation of a Japanese device font (S403) when it receives the inquiry (S402: Yes). More specifically, the Japanese device font installation inquiry unit f11 checks whether or not the storage device 23 stores a Japanese device font, and sends “Yes” to the printer driver D if the storage device 23 stores a Japanese device font while sending “No” if storage device 23 stores no Japanese device font. The controller firmware F then returns to the aforementioned control processing (S401).

On the other hand, the controller firmware F further determines whether or not it has received print data from the printer driver D (S404) if it receives no inquiry from the printer driver D (S402: No). The controller firmware F then returns to S401 if it receives no print data (S404: No).

The language unit f2 generates image data for the print processing by the printer engine 26 (S405) if the controller firmware F receives print data (S404: Yes). More specifically, the language unit f2 interprets the downloaded font data in outline or bitmap format to generate image data (bitmap data) for the print processing by the printer engine 26 if the current print settings indicate that downloaded font data will be used. On the other-hand, the language unit f2 generate image data (bitmap data) by using device fonts such as “HGMincho-Light” for “MS Mincho” etc. specified in the print data if the current print settings indicates that Japanese device fonts will be substituted for the system fonts.

The controller firmware F then transmits the image data (bitmap data) generated in S405 to the printer engine 26 (S406) before terminating the series of steps (End). The printer engine 26 prints an image based on the image data on recording paper when it receives the image data generated by the language unit f2.

As described above, the present embodiment comprises steps of: determining whether or not a Japanese device font is equipped with the printer 2; and changing default values of the font settings so that font data for executing print data will be downloaded if the printer 2 is not equipped with a Japanese device font. Therefore, the present embodiment can effectively prohibit print settings involving use of a Japanese device font if the printer 2 is not equipped with a Japanese device font, thereby avoiding abnormal termination of print processing due to the absence of a Japanese device font, which has hampered user-friendliness of the printer.

The present invention shall not be limited to the embodiment described above, but it can be modified in a various way within the scope of the appended claims. For example, the printing apparatus according to the present invention can be implemented by a function of a multi-functional peripheral (MFP) instead of the printer 2 illustrated in the aforementioned embodiment.

Moreover, the printer 2 can also inform font names of the Japanese device fonts installed onto itself in response to the inquiry from the PC 1, instead of sending a “Yes” or “No” signal. This will allow for more refined control processing by the PC 1. The particular language in the present invention is not limited to Japanese, but it can also be any other language using 2 byte characters such as Korean and Chinese.

The print setting apparatus according to the present embodiment can also be implemented by a dedicated hardware circuit capable of executing the aforementioned steps, or by a program executed by a CPU to perform the aforementioned steps. If the present invention is implemented by the latter means, the control program of the print setting apparatus can take a form of a computer readable recording medium such as a floppy® disk or a CD-ROM, or a downloadable file supplied on-line via a network such as Internet. In the former case, the program recorded on the computer readable recording medium is normally transmitted to a memory unit such as a flush ROM or a hard disk. The above program can also take a form of an application software program or a built-in function of the print setting apparatus.

What is claimed is:

1. A computer readable recording medium storing a print setting program for configuring print settings for print data, said program causing a computer to execute steps of:
(A) determining whether or not a printing apparatus for executing said print data is equipped with a device font in a particular language, based on information acquired from said printing apparatus: and
(B) changing default values of said print settings so that font data for executing said print data will be downloaded to said printing apparatus if said step (A) determines that said printing apparatus is not equipped with a device font in said particular language.

2. The recording medium as claimed in claim 1, wherein
said program further causes said computer to execute a step of (a) determining whether or not default values of font substitution settings regarding substitution of device fonts for system fonts used for generating said print data have been changed by user, prior to said step (B); and
said step (B) changes default values of said print settings only when said step (a) determines that default values of said font substitution settings have not been changed by user.

3. The recording medium as claimed in claim 1, wherein
said particular language is a language using multi-byte characters.

4. The recording medium as claimed in claim 3, wherein
said particular language is Japanese.

5. The recording medium as claimed in claim 1, wherein
said step (A) acquires said information in accordance with SNMP (Simple Network Management Protocol).

6. The recording medium as claimed in claim 1, wherein
said step (A) acquires said information using PJL (Printer Job Language) commands.

7. A print setting apparatus for configuring print settings for print data, comprising:
a determining unit for determining whether or not a printing apparatus for executing said print data is equipped with a device font in a particular language, based on information acquired from said printing apparatus; and
a setting changing unit for changing default values of said print settings so that font data for executing said print data will be downloaded to said printing apparatus when said determining unit determines that said printing apparatus is not equipped with a device font in said particular language.

8. The print setting apparatus as claimed in claim 7, wherein
said determining unit further determines whether or not default values of font substitution settings regarding substitution of device fonts for system fonts used for generating said print data have been changed by user; and
said setting changing unit changes default values of said print settings only when said determining unit determines that default values of said font substitution settings have not been changed by user.

9. The print setting apparatus as claimed in claim 7, wherein
said particular language is a language using multi-byte characters.

10. The print setting apparatus as claimed in claim 9, wherein
said specific language is Japanese.

11. The print setting apparatus as claimed in claim 7, wherein
said information is acquired in accordance with SNMP (Simple Network Management Protocol).

12. The print setting apparatus as claimed in claim 7, wherein
said information is acquired using PJL (Prime Job Language) commands.

13. A computer readable recording medium storing a control program of a printing apparatus for executing print data using one or more device fonts stored in a storage device, wherein
said control program causes said printing apparatus to execute a step of sending, in response to an inquiry from an external equipment, information to be used for determining whether or not a device font in a particular language is stored in said storage device to said external equipment.

14. The recording medium as claimed in claim 13, wherein
said particular language is a language using multi-byte characters.

15. The recording medium as claimed in claim 13, wherein
said particular language is Japanese.

16. The recording medium as claimed in claim 13, wherein
said inquiry is made in accordance with SNMP (Simple Network Management Protocol).

17. The recording medium as claimed in claim 13, wherein
said inquiry is made using PJL (Printer Job Language) commands.

18. A printing apparatus comprising:
a storage unit for storing more than one device fonts;
a print processing unit for executing print data using a device font stored in said storage unit; and
an information sending unit for sending, in response to an inquiry from an external equipment, information to be used for determining whether or not said storage unit stores a device font in a particular language to said external equipment,

19. The printing apparatus as claimed in claim 18, wherein
said particular language is a language using multi-byte characters.

20. The printing apparatus as claimed in claim 18, wherein
said particular language is Japanese.

21. The printing apparatus as claimed in claim 18, wherein
said inquiry is made in accordance with SNMP (Simple Network Management Protocol).

22. The printing apparatus as claimed in claim 18, wherein
said inquiry is made using PJL (Printer Job Language) commands.
